(19) United States
(12) Patent Application Publication
(10) Pub. No.: US 2007/0121498 A1
(43) Pub. Date: May 31, 2007

(54) System and method for transmitting non-real-time data in a broadband communication system

(75) Inventors: Young-Jun Park, Seoul (KR); Se-Youn Lim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/606,667

(22) Filed: Nov. 30, 2006

(30) Foreign Application Priority Data
Nov. 30, 2005 (KR) 2005-116012

(51) Int. Cl. H04L 12/26

(52) U.S. Cl. 370/229; 370/230

(57) ABSTRACT

A method is provided for transmitting non-real-time traffic in a broadband communication system. A Base Station (BS) transmits to Mobile Stations (MSs) status information corresponding to each service for transmission of non-real-time traffic. The MSs to the BS each send a bandwidth allocation request according to the status information provided from the BS.

### PRIORITY

This application claims the benefit under 35 U.S.C. §119(a) of an application entitled “System and Method for Transmitting Non-Real-Time Data in a Broadband Communication System” filed in the Korean Intellectual Property Office on Nov. 30, 2005 and assigned Serial No. 2005-116012, the entire contents of which are incorporated herein by reference.

### BACKGROUND OF THE INVENTION

1. Field of the Invention

The present invention relates generally to a Broadband Wireless Access (BWA) communication system, and in particular, to efficient access for non-real-time uplink traffic transmission of a Mobile Station (MS) in a BWA communication system.

2. Description of the Related Art

The technologies generally used for providing data services to users in the current wireless communication environment are classified into 2.5^{th} or 3^{rd} generation cellular mobile communication technology such as Code Division Multiple Access 2000 1x Evolution Data Optimized (CDMA2000 1xEVDO), General Packet Radio Services (GPRS) and Universal Mobile Telecommunication Service (UMTS), and Wireless Local Area Network (LAN) technology such as Institute of Electrical and Electronics Engineers (IEEE) 802.11 Wireless LAN.

The 3^{rd} generation cellular mobile communication technology mainly supports voice services via circuit-switched networks and provides packet data services in which subscribers can access the Internet in the broadband wireless communication environment.

The cellular mobile communication network has limitations in supporting high-speed packet data services. For example, the CDMA2000 1xEVDO system, which is a synchronous mobile communication system, supports a data rate up to 2.4 Mbps.

Along with the evolution of the mobile communication technologies, various local wireless access technologies such as Wireless LAN and Bluetooth have appeared. Such technologies cannot guarantee the mobility at the same level as that of the cellular mobile communication system. The local wireless access technologies are provided as an alternative proposal for providing high-speed data services in the wireless environment, replacing wired communication networks such as Cable Modem and x-Digital Subscriber Line (xDSL) in hot spot areas like public spaces and schools, or in the home network environment.

When the high-speed data services are provided with the Wireless LAN, there are limitations in providing public network services to users due not only to the highly restricted mobility and the narrow service coverage, but also to the radio interferences.

Therefore, many efforts are being made to overcome the foregoing limitations. For example, active research is being conducted on the portable Internet technology, also known as broadband wireless communication system, proposed to make up for defects of the cellular mobile communication system and the Wireless LAN, and standardization and development thereof is now in progress.

The broadband wireless communication system is a technology capable of allowing users to wirelessly receive high-speed data even while on the move. Basically, the broadband wireless communication system provides Quality of Service (QoS). That is, various QoS parameters including bandwidth undergo a change according to services provided from upper layers of an MS.

The broadband wireless communication system, unlike the wired communication networks, may suffer an abrupt change in physical media characteristics such as the data rate according to characteristics of wireless media and circumstances. It is impossible to estimate the change in the characteristics. The characteristic change does not cause serious problems for simple services like Internet search. However, for multimedia services like the moving image service, the characteristic change may cause considerable quality degradation in terms of delay and jitter. In addition, for the services requiring bandwidth guarantee, the characteristic change may cause quality degradation in terms of QoS. Along with the development of communication networks, because there is an increasing user demand for multimedia, it is considered that the QoS guarantee should necessarily be taken into account during the development of the communication system.

In order to guarantee the QoS for MSs, the broadband wireless communication system defines the following service classes, and performs scheduling in a Medium Access Control (MAC) layer.

In order to use the broadband wireless communication service, there is a need to generate a service flow for data transmission after network entry is completed. The term “service flow” as used herein refers to a unidirectional flow of packets on the connection between a Base Station (BS) providing specific QoS and an MS. A service flow that can be transmitted from a MAC layer of the MS to the BS is determined through a service flow established between the MS and the BS. A process of generating the service flow is achieved through Dynamic Service Addition (DSA).

A scheduling process of the MAC layer will now be described with reference to the uplink traffic with which the MS requests generation of a new service flow in the broadband wireless communication system.

In the broadband wireless communication system, the MS first sends to the BS a Dynamic Service Addition Request (DSA-REQ) message which is a MAC management message in the MAC layer.

Upon receipt of the DSA-REQ message, the BS performs scheduling capable of guaranteeing a service flow scheduling method and QoS parameter values, defined in the DSA-REQ message. As a scheduling scheme for guaranteeing the QoS, the broadband wireless communication system defines 5 service classes: Unsolicited Grant Service (UGS), real time Polling Service (rtPS), extended real time Polling Service (ertPS), non real time Polling Service (nrtPS), and Best Effort Service (BES).

A description will now be made of an example in which the BS performs scheduling using the UGS scheme from among the five (5) service classes to provide real-time packet service, for example, Voice over IP (VoIP) service, in the broadband wireless communication system.

Upon receipt of the DSA-REQ message from the MS, the BS performs scheduling based on the UGS scheme. The UGS scheduling, which is a scheduling scheme for supporting real-time service that periodically generates fixed-length data packets, supports T1/E1 (digital transport line) or VoIP services. In the UGS scheme, the MSs can be guaranteed their initially required wireless resources even though they do not contend with each other to be allocated wireless resources.

After performing the UGS-based scheduling, the BS provides information on the scheduling result to the MS using a DSA Response (DSA-RSP) message, which is a MAC management message, in response to the DSA-REQ message.

Upon receipt of the DSA-RSP message from the BS, the MS transmits desired VoIP packets through wireless resources corresponding to the scheduling result, determining that a service flow to the BS was generated.

However, for the downlink traffic with which the BS requests generation of a new service flow, the BS performs the same procedure as the above process except that the transmission direction of the MAC management messages, i.e. DSA-REQ message and the DSA-RSP messages, and the VoIP packets is opposed. As described above, a logical connection is generated between the MS and the BS through the DSA exchange process.

A description will now be given of a multicast polling and broadcast polling method of the BS, defined in the broadband wireless communication system.

Among the five (5) scheduling schemes described above, the UGS, the rtPS and the ertPS guarantee uplink delay of the MS below its maximum value in the process where the BS allocates an uplink bandwidth to the MS. Therefore, the three (3) scheduling schemes are used for real-time traffic transmission such as Voice over IP (VoIP) and Moving Picture Experts Group (MPEG).

However, in the nrtPS and the BES, the MSs participate in the contention in the process where the BS allocates uplink bandwidths to the MSs.

In the case of the nrtPS, MSs receiving the nrtPS belong to a multicast group. In this case, the multicast polling of the BS is transmitted to the MSs belonging to the multicast group, and the MSs belonging to the same multicast group contend with each other.

In the case of the BES, all MSs receiving the BES receive the broadcast polling from the BS. Therefore, all MSs receiving the broadcast service contend with each other at the same time.

In the nrtPS or the BES, the MSs, which have failed in the contention process, cannot be allocated uplink bandwidths. As a result, the failed MSs may suffer the delay. Therefore, the nrtPS and the BES are generally used for transmission of the non-real-time traffic.

The nrtPS or the BES of the broadband wireless communication system is provided that all MSs using the corresponding service should simultaneously send a bandwidth request for the multicast polling or broadcast polling.

However, in the nrtPS and BES schemes, the BS receives the bandwidth requests from all MSs simultaneously, regardless of its currently available uplink bandwidths. As a result, more MSs may fail in the contention. Further, the broadband wireless communication system is provided that the failed MSs should retry to send the bandwidth request to the BS after a lapse of a predetermined time. In this case, therefore, each of the MSs suffers a delay in the uplink undesirably.

Accordingly, there is a demand for a scheme capable of increasing bandwidth allocation efficiency for non-real-time traffic in transmitting uplink traffic from an MS to a BS in a broadband communication system.

### SUMMARY OF THE INVENTION

It is, therefore, an object of the present invention to provide a scheme for efficiently transmitting uplink traffic from an MS to a BS in a broadband communication system.

It is another object of the present invention to provide a scheme for increasing bandwidth allocation efficiency for non-real-time traffic in a broadband communication system.

It is further another object of the present invention to provide a scheme in which MSs receiving nrtPS or BES can adaptively request bandwidths according to the bandwidth use of a BS in a broadband communication system.

It is yet another object of the present invention to provide a scheme for increasing bandwidth utilization efficiency of each MS and reducing transmission delay of non-real-time traffic in a broadband communication system.

According to one aspect of the present invention, there is provided a method for transmitting non-real-time traffic in a broadband communication system. The method includes transmitting, by a Base Station (BS) to Mobile Stations (MSs), status information corresponding to each service for transmission of non-real-time traffic; and sending, by the MSs to the BS, a bandwidth allocation request according to the status information provided from the BS.

According to another aspect of the present invention, there is provided a method for allocating uplink bandwidth for transmission of non-real-time traffic by a Base Station (BS) in a broadband communication system. The method includes if there is bandwidth available for multicast polling, transmitting to Mobile Stations (MSs) status information based on the multicast polling in a multicast group; if there is no bandwidth available for the multicast polling, determining if there is bandwidth available for broadcast polling; if there is bandwidth available for broadcast polling, broadcasting to MSs status information based on the broadcast polling; receiving a bandwidth request from each of MSs that have received the status information; and allocating uplink bandwidth to a corresponding MS using a preset scheduling scheme according to a service type of the MSs that have sent the bandwidth request.

According to further another aspect of the present invention, there is provided a method for requesting bandwidth for transmission of non-real-time traffic in a broadband communication system. The method includes determining by a Mobile Station (MS) if multicast polling for its multicast group is received; and upon receipt of the multicast polling, requesting from a Base Station (BS) uplink bandwidth for receiving non real time Polling Service (nrtPS) according to status information transmitted from the BS.

According to yet another aspect of the present invention, there is provided a method for requesting bandwidth for transmission of non-real-time traffic in a broadband communication system. The method includes determining by a Mobile Station (MS) if broadcast polling is received; and upon receipt of the broadcast polling, requesting uplink bandwidth for receiving Best Effort Service (BES) from a Base Station (BS) according to status information transmitted from the BS.

According to still another aspect of the present invention, there is provided a system for transmitting non-real-time traffic in a broadband communication system. The system includes a Base Station (BS) for transmitting to each of Mobile Stations (MSs) status information corresponding to each service for transmission of non-real-time traffic, receiving a bandwidth request corresponding to the transmission of the status information, and allocating uplink bandwidth to a corresponding MS using a preset scheduling scheme according to a service type of the MSs that have requested the bandwidth.

According to still another aspect of the present invention, there is provided a system for transmitting non-real-time traffic in a broadband communication system. The system includes a Mobile Station (MS) for sending a bandwidth allocation request to a Base Station (BS) according to status information corresponding to each service, provided from the BS.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating a polling process of a BS according to the present invention;

FIG. 2 is a flowchart illustrating an uplink access process of an nrtPS MS according to the present invention; and

FIG. 3 is a flowchart illustrating an uplink access process of a BES MS according to the present invention.

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a scheme for transmitting uplink traffic from a Mobile Station (MS) to a Base Station (BS) in a broadband communication system. In particular, the present invention provides a system and method for allowing the MS to increase bandwidth allocation efficiency for non-real-time traffic during channel access.

More specifically, the present invention allows MSs receiving non Real-Time Polling Service (nrtPS) or Best Efforts Service (BES) to adaptively request bandwidths according to bandwidth use situation of the BS, thereby increasing their bandwidth utilization efficiency and thus reducing transmission delay of non-real-time traffic.

Generally, the broadband wireless communication system defines five (5) uplink data transmission scheduling schemes: Unsolicited Grant Service (UGS), real time Polling Service (rtPS), extended real time Polling Service (ertPS), non real time Polling Service (nrtPS), and Best Effort Service (BES).

Before a detailed description of the present invention is given, a description will be made of the five uplink data transmission scheduling schemes defined in the broadband communication system, and a method for transmitting data by an MS in each of the scheduling schemes.

The UGS represents a scheme in which the MS is periodically allocated from the BS, the uplink bandwidth whose delay is guaranteed and whose size is fixed. In the UGS, if a connection between the BS and the MS is formed, the BS allocates uplink bandwidth to the MS without a separate signaling process until the connection is released.

The rtPS represents a scheme in which the MS is periodically allocated from the BS, the uplink bandwidth whose delay is guaranteed and whose size is variable. An uplink bandwidth allocation procedure in the rtPS is as follows.

The BS transmits through the downlink unicast polling to an MS determined to receive the rtPS. Upon receipt of the unicast polling from the BS, the MS sends a bandwidth request to the BS through the uplink. Upon receipt of the bandwidth request from the MS, the BS allocates the uplink bandwidth requested by the MS through the downlink, if the bandwidth requested by the MS is available.

The ertPS represents a scheme in which the MS is periodically allocated from the BS, the uplink bandwidth whose delay is guaranteed and whose size is variable. An uplink bandwidth allocation procedure in the ertPS is performed as done in the rtPS.

The nrtPS represents a scheme in which the MS is allocated from the BS, the uplink bandwidth whose delay is not guaranteed and whose size is variable. An uplink bandwidth allocation procedure in the nrtPS is as follows.

The BS transmits through the downlink multicast polling to MSs determined to receive the nrtPS. Upon receipt of the multicast polling from the BS, all the MSs simultaneously send to the BS through the uplink a bandwidth request. All the MSs receiving the multicast polling from the BS contend with each other for the uplink bandwidth. Then the BS allocates the uplink bandwidth requested by the MSs through the downlink, for the MSs that have succeeded in the inter-MS contention.

The BES represents a scheme in which the MS is allocated from the BS, the uplink bandwidth whose delay is not guaranteed and whose size is variable. An uplink bandwidth allocation procedure in the BES is as follows.

The BS transmits through the downlink broadcast polling to MSs scheduled to receive the BES. Upon receipt of the broadcast polling from the BS, all the MSs simultaneously send to the BS through the uplink a bandwidth request. All the MSs receiving the broadcast polling from the BS contend with each other for the uplink bandwidth. Then the BS allocates the uplink bandwidth requested by the MSs through the downlink, for the MSs that have succeeded in the inter-MS contention.

As described above, in the broadband wireless communication system, the nrtPS or the BES provides that all MSs using the corresponding service simultaneously send a bandwidth request for the multicast polling or the broadcast polling. The BS receives bandwidth requests from all the MSs regardless of its currently available uplink bandwidth, causing an increase in the possibility that more MSs will fail in the contention. In addition, the failed MSs will re-send the bandwidth request to the BS after a lapse of a predetermined time, causing an increase in transmission delay in the uplink of each MS.

According to the present invention, MSs receiving the nrtPS or the BES can adaptively request bandwidths according to bandwidth availability of the BS. In this manner, it is possible to increase bandwidth utilization efficiency of each MS, and decrease transmission delay of non-real-time traffic.

In the present invention, the broadband wireless communication system includes a BS providing a broadband wireless data service and an MS receiving the service from the BS.

If the BS delivers polling to the MS supporting a particular service and then receives a bandwidth request from the MS, the BS performs uplink scheduling in response thereto and allocates the requested bandwidth to the corresponding MS.

Upon receipt of the polling of the corresponding scheduling service from the BS, if there is data to transmit, the MS sends a bandwidth request message to the BS. If the BS allocates a bandwidth in response to the bandwidth request, the MS transmits the transmission data. If the BS allocates no bandwidth, the MS repeatedly performs the above process after a lapse of the time preset in the system.

The present invention proposes a detailed process in which the BS delivers polling to the MS supporting the particular scheduling service, and another detailed process in which the MS sends a bandwidth request to the BS. As a result, in transmitting uplink traffic to the BS in the broadband communication system, the MS can increase bandwidth allocation efficiency for the non-real-time traffic.

Specifically, when delivering the polling to the MS, the BS provides the MS with status information related to the contention associated with the current service. Upon receipt of the status information, the MS sends a bandwidth request message using the probability calculated from the status information provided from the BS.

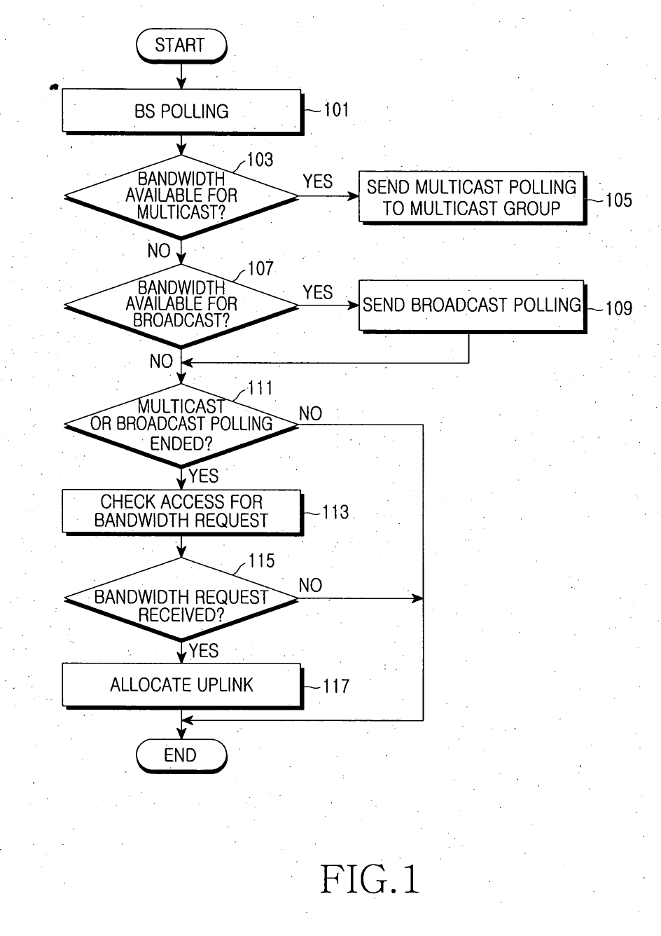

FIG. 1 is a flowchart illustrating a polling process of a BS according to the present invention.

Referring to FIG. 1, in step 101, the BS performs polling on a particular MS. In this step, the BS performs one of multicast polling and broadcast polling. The term “polling” as used herein refers to a transmission control scheme in which a communication system continuously checks a status of a particular program or device, for example, in which a BS continuously checks statuses of other programs or devices, for example, MSs. Generally, the polling represents a procedure for determining if connections to the MSs are established, and if there is a need for data transmission. For example, in the multi-drop or multi-point communication where several devices share the same circuit, a control device sends one message to each device, to determine if there is data to transmit, i.e. if the corresponding device desires to use the circuit.

The BS determines in step 103 if there is bandwidth available for the multicast polling. The BS first determines if there is bandwidth available for providing nrtPS, and then proceeds to step 105 or 107 according to the determination result.

If the BS has the bandwidth currently available for the nrtPS, the BS transmits multicast polling to a multicast group in step 105. In this case, the BS transmits, to the MS, status information including a size B_{nrtPS} of the bandwidth currently available for the nrtPS and the number N_{nrtPS} of MSs currently receiving service from the multicast group. After transmitting the multicast polling, the BS transmits the polling, making a change in the multicast group, until the bandwidth for providing the nrtPS is used up.

However, if there is no bandwidth available for the nrtPS, the BS determines in step 107 if there is bandwidth available for the broadcast polling. That is, the BS first transmits polling for the bandwidth for providing the nrtPS, and then uses the available bandwidth as a bandwidth for providing the BES.

If it is determined in step 107 that there is bandwidth available for the broadcast polling, i.e. there is bandwidth for providing the BES, the BS proceeds to step 109. Otherwise, the BS proceeds to step 111.

In step 109, the BS transmits information indicating the presence of the available bandwidth for the broadcast polling to the MSs receiving the BES, determining that there is bandwidth available for providing the BES. In this case, the BS transmits, to the MS, status information including a size B_{BE} of the bandwidth for currently providing the BES and the number N_{BE} of MSs currently receiving the BES.

The BS determines in step 111 if the multicast polling or the broadcast polling is completed. If it is determined that the multicast polling or the broadcast polling is completed, the BS proceeds to step 113. In step 113, the BS monitors whether there is a connection for bandwidth requests from the MSs receiving the status information. That is, the BS monitors whether there is contention over the bandwidth requested by the MSs. Through the contention between the MSs, the BS receives bandwidth requests from the MSs which are finally determined to use the uplink of the BS.

Subsequently, the BS determines in step 115 if there is a valid bandwidth request from the MSs. If there is no bandwidth request from the MSs, the BS ends the procedure. However, if there is a valid bandwidth request received from the MSs, the BS proceeds to step 117.

In step 117, upon receipt of a valid bandwidth request from a particular MS, the BS allocates an uplink bandwidth to the corresponding MS using a preset scheduling scheme according to the nrtPS or BES service.

As described above, the BS according to the present invention, unlike the conventional BS, provides the corresponding MS with bandwidth information for each of the currently available services and status information including the number of MSs receiving the corresponding service in the process of transmitting polling to the MSs. Based on the status information, the MSs receiving the nrtPS or the BES can adaptively request bandwidth according to bandwidth use situation of the BS. In this way, the BS can increase bandwidth utilization efficiency of each MS, and decrease transmission delay of the non-real-time traffic.

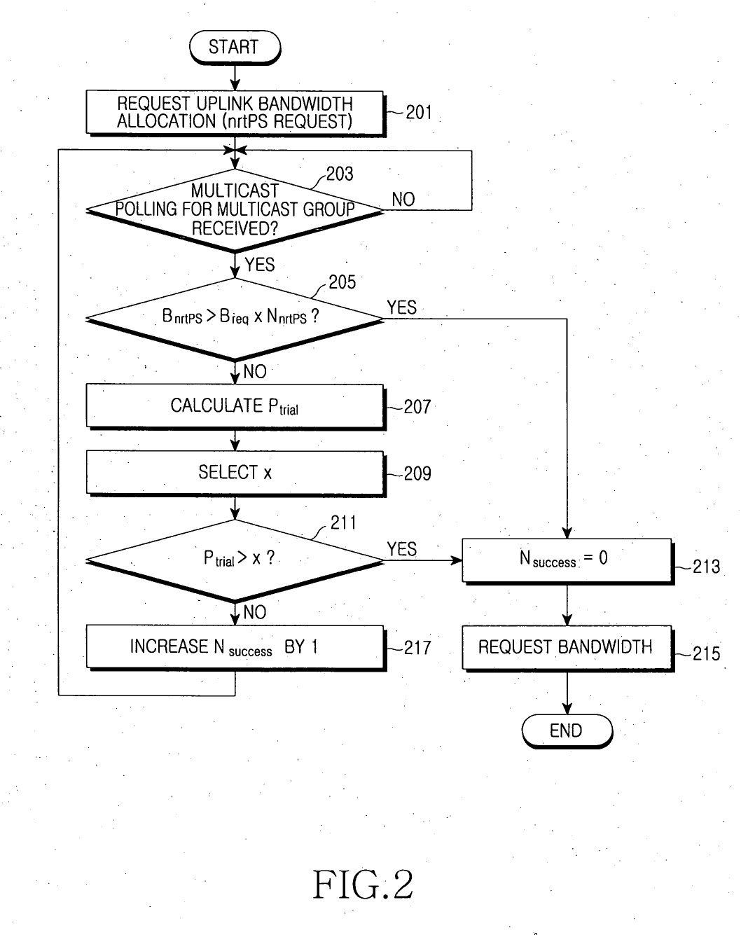

FIG. 2 is a flowchart illustrating an uplink access process of an nrtPS MS according to the present invention.

Referring to FIG. 2, in step 201, the MS starts an uplink bandwidth allocation request process for receiving the nrtPS. In step 203, the MS determines if multicast polling for its multicast group is received. If it is determined in step 203 that the multicast polling is not received, the MS waits for the multicast polling. However, if it is determined in step 203 that the multicast polling is received, the MS proceeds to step 205.

Upon receipt of the multicast polling from the BS to receive the nrtPS, the MS makes an uplink bandwidth request for receiving the nrtPS using such parameters as B_{nrtPS}, B_{req}, N_{nrtPS} and N_{success}.

B_{nrtPS} indicates the total bandwidth that the BS can currently provide for the nrtPS in the corresponding multicast group, B_{req} indicates the uplink bandwidth that the MS desires to request for the BS, N_{nrtPS} indicates the total number of MSs receiving the nrtPS in the same multicast group as that of the corresponding MS, and N_{success} indicates the number of successive fails for the case where the MS fails in the previous uplink bandwidth allocation process.

If the MS receives the multicast polling for its multicast group in step 203, the MS makes an uplink bandwidth request for receiving the nrtPS to the BS according to the status information transmitted from the BS in step 205.

More specifically, upon receipt of the multicast polling from the BS, the MS calculates in step 205 the product B_{req}×N_{nrtPS} of the uplink bandwidth B_{req} that it desires to request for the BS and the number N_{nrtPS} of MSs receiving the nrtPS in its multicast group, and compares the calculated value B_{req}×N_{nrtPS} with the total bandwidth B_{nrtPS} that the BS can provide for the nrtPS. If it is determined in step 205 that the total bandwidth B_{nrtPS} that the BS can provide for the nrtPS is greater than the calculated value B_{req}×N_{nrtPS}, the MS proceeds to step 213. Otherwise, if B_{nrtPS} is less than or equal to B_{req}×N_{nrtPS}, the MS proceeds to step 207.

If it is determined in step 205 that B_{nrtPS} is greater than B_{req}×N_{nrtPS}, the MS proceeds to step 213 where it sets the number N_{success} of successive fails to ‘0’, determining that its current contention for uplink bandwidth request is moderate. Thereafter, in step 215, the MS sends an uplink bandwidth request for receiving the nrtPS to the BS.

However, if it is determined in step 205 that B_{nrtPS} is less than or equal to B_{req}×N_{nrtPS}, the MS proceeds to step 207 where it calculates a persistent probability Pₜᵣᵢₐₗ, determining that its current contention for the uplink bandwidth request is severe. The persistent probability Pₜᵣᵢₐₗ indicates a function having the parameters B_{req}, B_{nrtPS}, N_{nrtPS} and N_{success} as variables, and can be expressed as in Equation (1):
Pₜᵣᵢₐₗ={min[B_{req}/(B_{nrtPS}/N_{nrtPS}),1]}^{N}^{_{success}} (1)

As shown in Equation (1), Pₜᵣᵢₐₗ=1 for N_{success}=0, and Pₜᵣᵢₐₗ=1 for B_{req}=(B_{nrtPS}/N_{nrtPS})

In step 209, the MS selects a uniformly-distributed probability variable ‘x’. The probability variable ‘x’ indicates a variable having a value between 0 and 1 (0<x<1).

In step 211, the MS compares the persistent probability Pₜᵣᵢₐₗ calculated in step 207 with the probability variable ‘x’ selected in step 209, and proceeds to step 213 or 217 according to the comparison result.

As a result of the comparison in step 211, if the persistent probability Pₜᵣᵢₐₗ is greater than the probability variable ‘x’, the MS adjusts the number N_{success} of successive fails to ‘0’ in step 213, considering that it has succeeded in persistent test. Thereafter, in step 215, the MS sends an uplink bandwidth request for receiving the nrtPS to the BS.

However, as a result of the comparison in step 211, if the persistent probability Pₜᵣᵢₐₗ is less than or equal to the probability variable ‘x’, the MS increases the number N_{success} of successive fails by 1 (N_{success}=N_{success}+1) in step 217, considering that it has failed in the persistent test. Thereafter, the MS returns to step 203, stopping transmission of the bandwidth allocation request.

In step 209, the probability variable ‘x’ is selected on a uniform distribution basis. Therefore, if the persistent probability Pₜᵣᵢₐₗ is less than or equal to the probability variable ‘x’ in step 211, the average delay time required by the MS to send an nrtPS uplink request bandwidth request is 1/x.

As described above, the nrtPS MS (i.e. MS receiving the nrtPS) according to the present invention, unlike the conventional MS, requests dynamic bandwidth allocation based on the status information transmitted from the BS. Based on the status information, the nrtPS MSs proposed by the present invention can adaptively request bandwidth according to bandwidth use situation of the BS. As a result, it is possible to increase bandwidth utilization efficiency of each MS, and decrease transmission delay of non-real-time traffic.

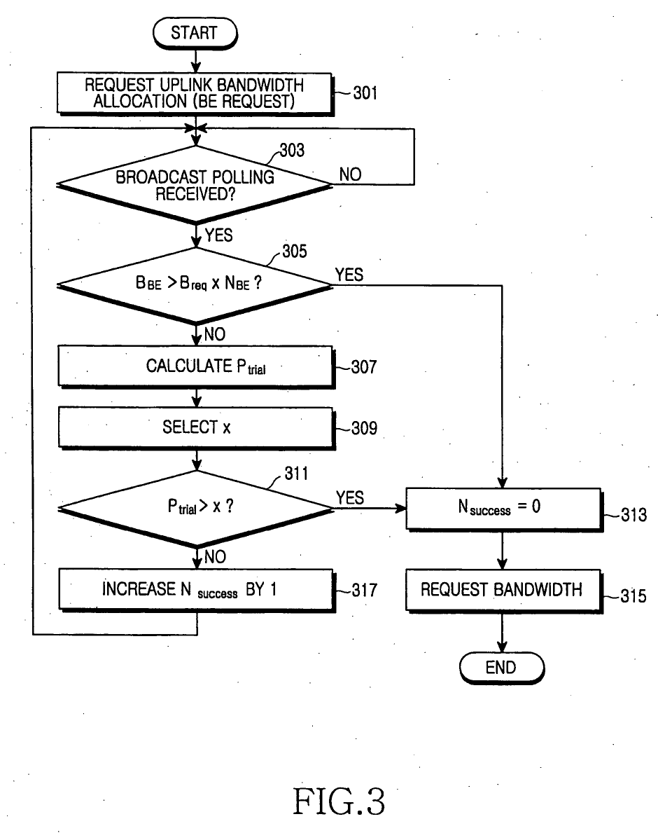

FIG. 3 is a flowchart illustrating an uplink access process of a BES MS according to the present invention.

Referring to FIG. 3, in step 301, the MS starts an uplink bandwidth allocation request process for receiving the BES. In step 303, the MS determines if broadcast polling is received from the BS. If it is determined in step 303 that the broadcast polling is not received, the MS waits for the broadcast polling. However, if it is determined in step 303 that the broadcast polling is received, the MS proceeds to step 305.

Upon receipt of the broadcast polling from the BS to receive the BES, the MS makes an uplink bandwidth request for receiving the BES using such parameters as B_{BE}, B_{req}, N_{BE} and N_{success}.

B_{BE} indicates the total bandwidth that the BS can currently provide for the BES, B_{req} indicates the uplink bandwidth that the MS desires to request for the BS, N_{BE} indicates the total number of MSs receiving the BES, and N_{success} indicates the number of successive fails for the case where the MS fails in the previous uplink bandwidth allocation process.

If the MS receives the broadcast polling in step 303, the MS makes an uplink bandwidth request for receiving the BES to the BS according to the status information transmitted from the BS in step 305.

More specifically, upon receipt of the broadcast polling from the BS, the MS calculates in step 305 the product B_{req}×N_{BE} of the uplink bandwidth B_{req} that it desires to request for the BS and the total number N_{BE} of MSs currently receiving the BES from the BS, and compares the calculated value B_{req}×N_{BE} with the total bandwidth B_{BE} that the BS can provide for the BES. As a result of the comparison in step 305, if the total bandwidth B_{BE} that the BS can provide for the BES is greater than the calculated value B_{req}×N_{BE}, the MS proceeds to step 313. Otherwise, if B_{BE} is less than or equal to B_{req}×N_{BE}, the MS proceeds to step 307.

If it is determined in step 305 that B_{BE} is greater than B_{req}×N_{BE}, the MS proceeds to step 313 where it sets the number N_{success} of successive fails to ‘0’, determining that its current contention for uplink bandwidth request is moderate. Thereafter, in step 315, the MS sends an uplink bandwidth request for receiving the BES to the BS.

However, if B_{BE} is less than or equal to B_{req}×N_{BE} in step 305, the MS proceeds to step 307 where it calculates a persistent probability Pₜᵣᵢₐₗ, determining that its current contention for the uplink bandwidth request is severe. The persistent probability Pₜᵣᵢₐₗ indicates a function having the parameters B_{req}, B_{BE}, N_{BE} and N_{success} as variables, and can be expressed as in Equation (2):
Pₜᵣᵢₐₗ={min[B_{req}/(B_{BE}/N_{BE}),1]}^{N}^{_{success}} (2)

As shown in Equation (2), Pₜᵣᵢₐₗ=1 for N_{success}=0, and Pₜᵣᵢₐₗ=1 for B_{req}=(B_{BE}/N_{BE}).

In step 309, the MS selects a uniformly-distributed probability variable ‘x’. The probability variable ‘x’ indicates a variable having a value between 0 and 1 (0<x<1).

In step 311, the MS compares the persistent probability Pₜᵣᵢₐₗ calculated in step 307 with the probability variable ‘x’ selected in step 309, and proceeds to step 313 or 217 according to the comparison result.

As a result of the comparison in step 311, if the persistent probability Pₜᵣᵢₐₗ is greater than the probability variable ‘x’, the MS adjusts the number N_{success} of successive fails to ‘0’ in step 313, considering that it has succeeded in persistent test. Thereafter, in step 315, the MS sends an uplink bandwidth request for receiving the BES to the BS.

However, as a result of the comparison in step 311, if the persistent probability Pₜᵣᵢₐₗ is less than or equal to the probability variable ‘x’, the MS increases the number N_{success} of successive fails by 1 (N_{success}=N_{success}+1) in step 317, considering that it has failed in the persistent test. Thereafter, the MS returns to step 303, stopping transmission of the bandwidth allocation request.

In step 309, the probability variable ‘x’ is selected on a uniform distribution basis. Therefore, if the persistent probability Pₜᵣᵢₐₗ is less than or equal to the probability variable ‘x’ in step 311, the average delay time required by the MS to send an BES uplink request bandwidth request is 1/x.

As described above, the BES MS (i.e. MS receiving the BES) according to the present invention, unlike the conventional MS, requests dynamic bandwidth allocation based on the status information transmitted from the BS and the bandwidth information for each of the currently available services. Based on the status information, the BES MSs of the present invention can adaptively request bandwidth according to bandwidth use situation of the BS. As a result, it is possible to increase bandwidth utilization efficiency of each MS, and decrease transmission delay of non-real-time traffic.

As can be understood from the foregoing description, the non-real-time traffic transmission method of the present invention can efficiently transmit/receive non-real-time traffic between BSs in the broadband communication system, contributing to an increase in bandwidth allocation efficiency for the non-real-time traffic. Further, in the broadband communication system, the MSs receiving the nrtPS or the BES can adaptively request bandwidth according to bandwidth use situation of the BS.

Moreover, the MS can perform a dynamic bandwidth allocation request using the status information transmitted from the BS and its current regional information. In this manner, it is possible to reduce the bandwidth allocation request fail rate of the MS and increase the wireless resource utilization efficiency. In addition, based on the status information provided from the BS, the MS can adaptively request bandwidth according to bandwidth use situation of the BS, contributing to an increase in bandwidth utilization efficiency of each MS and a decrease in transmission delay of non-real-time traffic.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting non-real-time traffic in a broadband communication system, the method comprising the steps of:
transmitting, by a Base Station (BS) to Mobile Stations (MSs), status information corresponding to each service for transmission of non-real-time traffic; and
sending, by the MSs to the BS, a bandwidth allocation request according to the status information provided from the BS.

2. The method of claim 1, wherein the status information corresponding to the service includes information on a bandwidth size available for non real time Polling Service (nrtPS) and information on the total number of MSs receiving the nrtPS in a multicast group to which the MS currently belongs.

3. The method of claim 1, wherein the status information corresponding to the service includes information on a bandwidth size available for Best Effort Service (BES) and information on the total number of MSs currently receiving the BES service.

4. The method of claim 1, further comprising, upon receipt of a bandwidth request from particular MSs, allocating by the BS an uplink bandwidth to a corresponding MS using a preset scheduling scheme according to the nrtPS or BES service.

5. The method of claim 1, further comprising adaptively requesting bandwidth according to status information for each individual service, provided from the BS, by the MS receiving the service from the BS.

6. The method of claim 1, wherein the MS performs uplink bandwidth request using specific parameters corresponding to the service that the MS desires to receive from the BS.

7. The method of claim 6, wherein the specific parameters included any one of a parameter indicating the total bandwidth that the BS can currently provide for the corresponding service, a parameter indicating an uplink bandwidth that the MS desires to request for the BS, a parameter indicating the total number of MSs receiving the same service as the service that the MS is currently receiving, and a parameter indicating the number of successive fails for the case where the MS fails in a previous uplink bandwidth allocation process.

8. A method for allocating uplink bandwidth for transmission of non-real-time traffic by a Base Station (BS) in a broadband communication system, the method comprising the steps of:
if there is bandwidth available for multicast polling, transmitting to Mobile Stations (MSs) in a multicast group status information based on the multicast polling;
if there is no bandwidth available for the multicast polling, determining if there is bandwidth available for broadcast polling;
if there is bandwidth available for broadcast polling, broadcasting to MSs status information based on the broadcast polling;
receiving a bandwidth request from each of MSs that have received the status information; and
allocating uplink bandwidth to a corresponding MS using a preset scheduling scheme according to a service type of the MSs that have sent the bandwidth request.

9. The method of claim 8, wherein the status information based on the multicast polling includes information on a bandwidth size available for the multicast polling and information on the total number of MSs receiving the multicast polling in the multicast group.

10. The method of claim 8, wherein the status information based on the broadcast polling includes information on a bandwidth size currently available for the broadcast polling and information on the total number of MSs currently receiving the broadcast polling.

11. The method of claim 8, wherein upon receipt of a bandwidth request from specific MSs, the BS allocates uplink bandwidth to a corresponding MS using a scheduling scheme corresponding to non Real-Time Polling Service (nrtPS) or Best Effort Service (BES).

12. The method of claim 8, further comprising, after completing the multicast polling and the broadcast polling, monitoring by the BS whether there is a connection for bandwidth requests from specific MSs receiving the status information.

13. The method of claim 8, wherein the BS monitors contention for bandwidth allocation requests of the MSs, and receives bandwidth requests from the MSs that use an uplink of the BS through the contention.

14. A method for requesting bandwidth for transmission of non-real-time traffic in a broadband communication system, the method comprising the steps of:
determining by a Mobile Station (MS) if multicast polling for its multicast group is received; and
upon receipt of the multicast polling, requesting from a Base Station (BS) uplink bandwidth for receiving non real time Polling Service (nrtPS) according to status information transmitted from the BS.

15. The method of claim 14, further comprising:
upon receipt of the multicast polling from the BS, calculating a product B_{req}×N_{nrtPS} of uplink bandwidth B_{req} that the MS desires to request for the BS, and the total number N_{nrtPS} of MSs receiving the nrtPS in the multicast group; and
comparing the calculated product B_{req}×N_{nrtPS} with the total bandwidth B_{nrtPS} that the BS can provide for the nrtPS.

16. The method of claim 15, further comprising, if the total bandwidth B_{nrtPS} is greater than the calculated product B_{req}×N_{nrtPS}, setting by the MS the number N_{success} of successive fails to zero (0), and then requesting uplink bandwidth for receiving the nrtPS.

17. The method of claim 15, further comprising:
calculating a persistent probability Pₜᵣᵢₐₗ, if the total bandwidth B_{nrtPS} is less than or equal to the calculated product B_{req}×N_{nrtPS}; and
selecting a uniformly-distributed probability variable ‘x’, and comparing the calculated persistent probability Pₜᵣᵢₐₗ with the selected probability variable ‘x’.

18. The method of claim 17, wherein the persistent probability Pₜᵣᵢₐₗ is calculated by
Pₜᵣᵢₐₗ={min[B_{req}/(B_{nrtPS}/N_{nrtPS}),1]}^{N}^{_{success}}
where Pₜᵣᵢₐₗ denotes a persistent probability, Pₜᵣᵢₐₗ=1 for N_{success}=0, and Pₜᵣᵢₐₗ=1 for B_{req}=(B_{nrtPS}/N_{nrtPS}).

19. The method of claim 17, further comprising:
if the persistent probability Pₜᵣᵢₐₗ is greater than the probability variable ‘x’, setting the number N_{success} of successive fails to zero (0), and requesting uplink bandwidth for receiving the nrtPS; and
if the persistent probability Pₜᵣᵢₐₗ is less than or equal to the probability variable ‘x’, increasing number N_{success} of successive fails by one.

20. The method of claim 14, wherein the MS receiving service from the BS adaptively requests bandwidth according to status information for each individual service, provided from the BS.

21. The method of claim 14, wherein the MS performs uplink bandwidth request using specific parameters corresponding to a service that the MS desires to receive from the BS.

22. The method of claim 21, wherein the specific parameters include at least one of a parameter indicating the total bandwidth that the BS can currently provide for the corresponding service, a parameter indicating an uplink bandwidth that the MS desires to request for the BS, a parameter indicating the total number of MSs receiving the same service as the service that the MS is currently receiving, and a parameter indicating the number of successive fails for the case where the MS fails in a previous uplink bandwidth allocation process.

23. A method for requesting bandwidth for transmission of non-real-time traffic in a broadband communication system, the method comprising the steps of:
determining by a Mobile Station (MS) if broadcast polling is received; and
upon receipt of the broadcast polling, requesting uplink bandwidth for receiving Best Effort Service (BES) from a Base Station (BS) according to status information transmitted from the BS.

24. The method of claim 23, comprising:
upon receipt of the broadcast polling from the BS, calculating a product B_{req}×N_{BE} of uplink bandwidth B_{req} that the MS desires to request for the BS, and the total number N_{BE} of MSs currently receiving the BES from the BS; and
comparing the calculated product B_{req}×N_{BE} with the total bandwidth B_{BE} that the BS can provide for the BES.

25. The method of claim 24, comprising the step of, if the total bandwidth B_{BE} is greater than to the calculated product B_{req}×N_{BE}, setting by the MS the number N_{success} of successive fails to zero (0), and then requesting uplink bandwidth for receiving the BES.

26. The method of claim 24, further comprising:
calculating a persistent probability Pₜᵣᵢₐₗ, if the total bandwidth B_{BE} is less than or equal to the calculated product B_{req}×N_{BE}; and
selecting a uniformly-distributed probability variable ‘x’, and comparing the calculated persistent probability Pₜᵣᵢₐₗ with the selected probability variable ‘x’.

27. The method of claim 26, wherein the persistent probability Pₜᵣᵢₐₗ is calculated by
Pₜᵣᵢₐₗ={min[B_{req}/(B_{req}/N_{BE}),1]}^{N}^{_{success}}
where Pₜᵣᵢₐₗ denotes a persistent probability, Pₜᵣᵢₐₗ=1 for N_{success}=0, and Pₜᵣᵢₐₗ=1 for B_{req}=(B_{BE}/N_{BE}).

28. The method of claim 26, further comprising:
if the persistent probability Pₜᵣᵢₐₗ is greater than the probability variable ‘x’, setting the number N_{success} of successive fails to zero (0), and requesting uplink bandwidth for receiving the BES; and
if the persistent probability Pₜᵣᵢₐₗ is less than or equal to the probability variable ‘x’, increasing number N_{success} of successive fails by one.

29. The method of claim 23, wherein the MS receiving service from the BS adaptively requests bandwidth according to status information for each individual service, provided from the BS.

30. The method of claim 23, wherein the MS performs uplink bandwidth request using specific parameters corresponding to a service that the MS desires to receive from the BS.

31. The method of claim 30, wherein the specific parameters include at least one of a parameter indicating the total bandwidth that the BS can currently provide for the corresponding service, a parameter indicating an uplink bandwidth that the MS desires to request for the BS, a parameter indicating the total number of MSs receiving the same service as the service that the MS is currently receiving, and a parameter indicating the number of successive fails for the case where the MS fails in a previous uplink bandwidth allocation process.

32. A system for transmitting non-real-time traffic in a broadband communication system, comprising:
a Base Station (BS) for transmitting to each of Mobile Stations (MSs) status information corresponding to each service for transmission of non-real-time traffic, receiving a bandwidth request corresponding to the transmission of the status information, and allocating uplink bandwidth to a corresponding MS using a preset scheduling scheme according to a service type of the MSs that have requested the bandwidth.

33. The system of claim 32, wherein the status information transmitted by the BS includes information on a bandwidth size available for non Real-Time Polling Service (nrtPS) and information on the total number of MSs receiving the nrtPS in a multicast group to which the MS currently belongs.

34. The system of claim 32, wherein the status information transmitted by the BS includes information on a bandwidth size available for Best Effort Service (BES) and information on the total number of MSs currently receiving the BES service.

35. The system of claim 32, wherein upon receipt of a bandwidth request from particular MSs, the BS allocates an uplink bandwidth to a corresponding MS using a preset scheduling scheme according to the nrtPS or BES service.

36. A system for transmitting non-real-time traffic in a broadband communication system, comprising:
a Mobile Station (MS) for sending a bandwidth allocation request to a base station (BS) according to status information corresponding to each service, provided from the BS.

37. The system of claim 36, wherein the MS adaptively requests bandwidth according to the status information for each individual service, provided from the BS.

38. The system of claim 36, wherein the MS performs uplink bandwidth request using specific parameters corresponding to a service that the MS desires to receive from the BS.

39. The system of claim 38, wherein the specific parameters include at least one of a parameter indicating the total bandwidth that the BS can currently provide for the corresponding service, a parameter indicating an uplink bandwidth that the MS desires to request for the BS, a parameter indicating the total number of MSs receiving the same service as the service that the MS is currently receiving, and a parameter indicating the number of successive fails for the case where the MS fails in a previous uplink bandwidth allocation process.
